(19) United States
(12) Patent Application Publication
(10) Pub. No.: US 2005/0238472 A1
(43) Pub. Date: Oct. 27, 2005

(54) Wheelchair retention device and method

(75) Inventors: Elizabeth Sobota, Rochester, IN (US); James Dupuy, Winamac, IN (US); Fred W. Malchow, Star City, IN (US)

Correspondence Address: MICHAEL BEST & FRIEDRICH LLC, 401 NORTH MICHIGAN AVENUE, SUITE 1900, CHICAGO, IL, 60611-4212, US

(73) Assignee: The Braun Corporation, Winamac, IN (US)

(21) Appl. No.: 11/089,345

(22) Filed: Mar. 24, 2005

Related U.S. Application Data
(60) Provisional application No. 60/555,761, filed on Mar. 24, 2004.

(51) Int. Cl. B60P 1/00

(52) U.S. Cl. 414/546

(57) ABSTRACT

In some embodiments, a wheelchair retention device for a wheelchair lift is provided at a height no greater than about the center of gravity of a wheelchair on the lift. In some embodiments, the retention device is a seatbelt-like device mounted to lift handrails and elevated above the platform surface. Also, in some embodiments, a damped retention device is provided. The damped retention device can include an extendable non-locking belt that slows a wheelchair or other object contacting the retention device by using friction forces. In some embodiments, the wheelchair can contact the damped retention device prior to contacting the outboard rollstop, and is slowed substantially, thereby preventing the wheelchair from tipping or flipping over upon contacting the rollstop and retaining the wheelchair on the lift.

### CROSS-REFERENCE TO RELATED APPLICATIONS

Priority is hereby claimed to U.S. provisional patent application No. 60/555,761 filed on Mar. 24, 2004, the entire contents of which are incorporated herein by reference.

### FIELD OF THE INVENTION

This invention relates generally to lifts, and more particularly, to vehicle lifts and retention devices for vehicle lifts.

### BACKGROUND OF THE INVENTION

The National Highway Traffic Safety Administration (NHTSA), Department of Transportation has adopted a new rule establishing an equipment standard that specifies requirements for wheelchair lifts to prevent injuries and fatalities during lift operation. The standard requires lifts to meet minimum platform dimensions, maximum size limits on platform protrusions and gaps, handrails, a threshold warning system, and retaining barriers, among other things.

Retaining barriers for wheelchair lifts are well known and are typically embodied by an outboard barrier such as a rollstop, which pivots or is otherwise moved between substantially vertical and horizontal positions. In its vertical barrier position, the rollstop is operative to prevent a wheelchair occupant from accidentally falling from the lift platform's outboard edge, particularly when it is raised above ground elevation. Similarly, inboard rollstops are often employed to prevent a wheelchair occupant from accidentally falling from the lift platform's inboard edge and becoming pinned between the lift and the vehicle. In certain lifts, the outboard rollstop may either be supplemented or replaced with a seatbelt-like retention device. Such devices typically have a fixed-length belt that typically spans the entire width of the lift platform. The seatbelt-like retention device is often located either proximate the handrails or the outboard edge of the platform. Typically, the seatbelt-like device is elevated a predetermined distance above the platform surface by attaching the belt to handrails or other components of the lift platform. Although some seatbelt-like retention devices may have a retractable belt to prevent damage to the belt during lift stowage and the like, extension of the belt may be limited by either a predetermined belt length or by a belt retractor. If included, the belt retractor may be operative to lock the belt with a centrifugal clutch or like mechanism, thereby presenting a substantially rigid barrier.

NHTSA standards require that the barrier device be designed to ensure that the wheelchair is not capable of climbing over the barrier. Moreover, the standards require that after contacting the barrier, a wheelchair must remain upright with all of its wheels on the platform surface (i.e., not tip or flip over). Since it may be difficult or impractical to employ a rollstop that, by itself, satisfies these standards, an additional barrier mechanism may be needed. For example, to inhibit a wheelchair (particularly a powered wheelchair) from climbing over a rollstop, it must be adequately tall. However, tall rollstops may be impractical for various reasons, including lift or vehicle space limitations, power constraints relative to rollstop actuation, and other factors. Therefore, in view of the foregoing, under certain conditions, it may be desirable or advantageous to employ a seatbelt-like retention device or to supplement a rollstop with a seatbelt-like retention device.

### SUMMARY

Some embodiments of the present invention provide an occupant lift for a vehicle, the occupant lift adapted to support a wheelchair and comprising a platform coupled to and movable to different positions with respect to the vehicle, the platform comprising a top surface adapted to support the wheelchair on the lift; an inboard end adjacent the vehicle when the platform is deployed; an outboard end opposite the inboard end; and an elongated barrier having a first position when the platform is deployed to block occupant movement off of the outboard end of the platform, wherein the elongated barrier is located a distance from the top surface of the platform no greater than about a height of a center of gravity of the wheelchair upon the platform.

In some embodiments of the present invention, an occupant retention device for a vehicular occupant lift having a platform with an inboard end and an outboard end is provided, and comprises an elongated barrier adapted to be coupled to the lift and movable between an extended position in which the elongated barrier is positioned to block occupant movement off of the outboard end of the platform, and a retracted position in which the elongated barrier does not block occupant movement off of the outboard end of the platform; and a damper coupled to the elongated barrier, the damper exerting a force resisting motion of the elongated barrier in at least one direction in order to reduce the rate of extension of the elongated barrier.

Some embodiments of the present invention provide a method of controlling occupant movement from a platform of a vehicle occupant lift adapted to support a wheelchair, wherein the method comprises extending an elongated barrier to an extended position across the platform at a location above and disposed from a top surface of the platform by a distance no greater than about a height of a center of gravity of the wheelchair; securing the elongated barrier in the extended position; and blocking the occupant from passing across an end of the platform with the elongated barrier.

In some embodiments of the present invention, a method of controlling occupant movement from a platform of a vehicle occupant lift is provided, and comprises extending an elongated barrier to an extended position across the platform at a location above and disposed from a top surface of the platform; securing the elongated barrier in the extended position; blocking the occupant from passing across an end of the platform with the elongated barrier in the extended position; and exerting a damping force resisting further extension of the elongated barrier responsive to occupant movement against the elongated barrier.

Some embodiments of the present invention provide an occupant retention device for a vehicular occupant lift having a platform with an inboard end, an outboard end, and a top surface adapted to support a wheelchair, wherein the occupant retention device comprises an elongated barrier adapted to be coupled to the vehicular occupant lift in a first position located a distance above the top surface of the platform no greater than about a height of a center of gravity of the wheelchair upon the platform and in which the elongated barrier blocks occupant movement off of the outboard end of the platform.

### BRIEF DESCRIPTION OF THE DRAWINGS

FIG. 1 illustrates a left side perspective view of a first embodiment of the retention device employed with an exemplary under vehicle lift;

FIG. 2 illustrates a right side perspective view of the embodiment of FIG. 1;

FIG. 3 illustrates a perspective view of an exemplary parallel arm lift with a second embodiment of the retention device including a damping mechanism;

FIGS. 4A-D illustrate the damping mechanism of FIG. 3;

FIGS. 5A-C illustrate the bracket of the damping mechanism of FIG. 3;

FIGS. 6A-B illustrate the adjustable pin of the damping mechanism of FIG. 3;

FIGS. 7A-C illustrate the fixed pins of the damping mechanism of FIG. 3;

FIGS. 8A-C illustrate another embodiment of the damping mechanism of FIG. 3 including a centrifugal clutch mechanism;

FIG. 9 illustrates the centrifugal clutch plate of FIGS. 8A-C; and

FIG. 10 illustrates the centrifugal clutch plate driver of FIGS. 8A-C.

### DETAILED DESCRIPTION

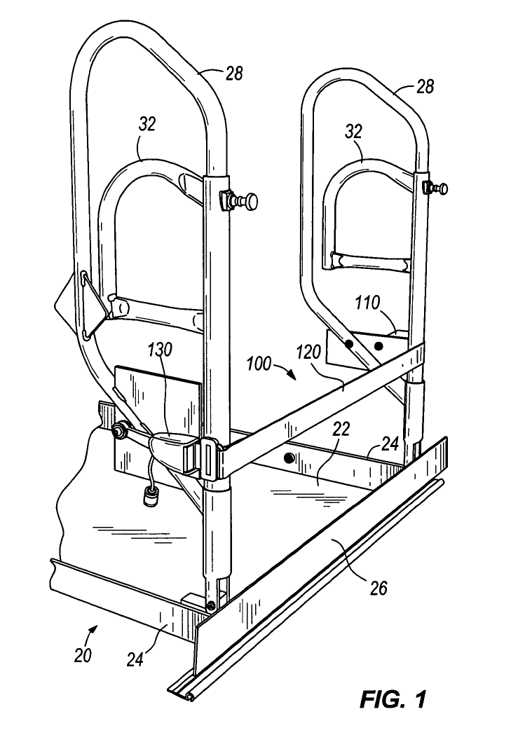

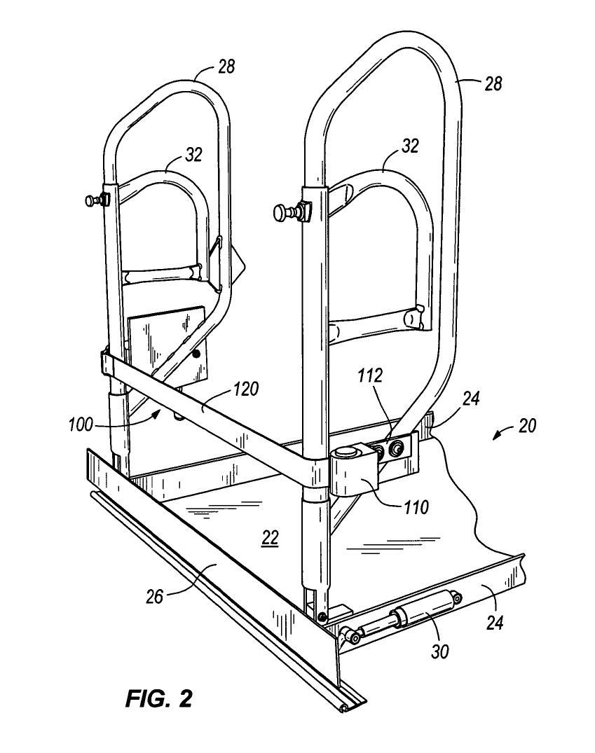

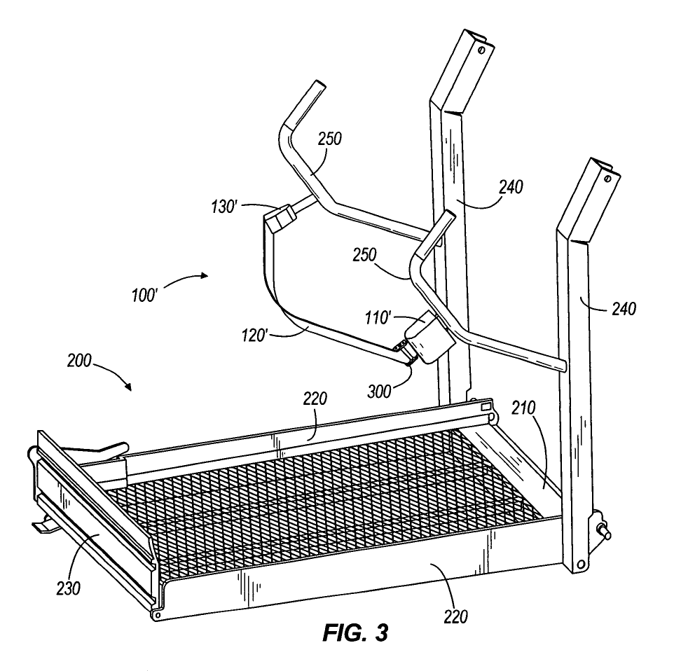

Referring now to the figures, and particularly FIGS. 1 and 2, a wheelchair lift having a first embodiment of the retention device is illustrated. As shown, the wheelchair lift is a stepwell, under floor, or under vehicle lift (UVL), however, the retention device may be used with other types of lifts as well, such as parallel arm lifts (FIG. 3). The wheelchair lift 20 includes a lift platform 22 with sidewalls 24 and a movable rollstop 26 at the outboard edge of the platform 22. The lift 20 is operable to enable a mobility challenged individual using a wheelchair, scooter, walker or the like to enter and exit a vehicle, whereby the lift 20 is moved between the transfer level (i.e., vehicle floor elevation) and the ground level. As shown in FIG. 2, the rollstop 26 is moved by an actuator 30. The actuator 30 may be hydraulic or electric and is operative to move the rollstop 26 between a substantially vertical (barrier) orientation and a horizontal (bridging) orientation. The rollstop 26 is oriented relative to the platform's elevation to prevent a lift user from rolling off the outboard edge of the platform 22, particularly when it is elevated above ground level. The lift 20 includes a pair of handrails 28 adjacent the outboard edge of the platform 22. The handrails 28 are spaced apart approximately by the width of the platform 20, and are sized and shaped to assist the lift user to enter and exit the lift 20. As shown, each handrail 28 may include an assist 32 if desired. The assists 32 are known in the art for enhancing an ambulatory user's safety when entering and exiting the vehicle.

A wheelchair retention device 100 is affixed to the handrails 28 and spans the width of the platform 22 proximate the outboard rollstop 26. The retention device 100 includes a belt retractor 110, a belt 120, and a buckle 130, and presents a substantially rigid barrier that is operative to prevent a lift occupant from falling off the outboard edge of the platform 22. As best shown in FIG. 2, the retractor 110 is attached to one handrail 28 by through-bolting the retractor 110 to an interface plate or bracket 112. If desired, the retractor 110 may be omitted and a first end of the belt 120 may be bolted or otherwise permanently affixed to one handrail 28. The retractor 110 is, however, advantageously provided to retract the belt 120, thereby providing quick and easy belt storage and obviating damage to the belt such as, for example, when the lift 20 is stowed. The retractor 110 includes a spring-biased spool (not shown) disposed within a housing. The first end of the belt 120 is coupled to the spool, and the housing is sized and shaped to store the belt 120 when wound on the spool. Additionally, the retractor 110 may include a locking mechanism (also not shown) having a centrifugal clutch or the like (an example of which is described in greater detail below in connection with FIGS. 3-10), which inhibits the spool from releasing a spooled portion of the belt 120. Alternatively, the belt 120 may have a fixed length substantially corresponding with the width of the platform 22. The belt 120 may be made of a nylon webbing or other suitable material known in the art.

The second end of the belt 120 includes a latch plate (not shown) which can be sewed, welded, or otherwise permanently attached to the belt 120. The latch plate is sized and shaped to matingly engage the buckle 130 when inserted therein. The buckle 130, as with the retractor 110, is bolted to an interface plate on the other handrail 28 and thereby permanently affixed to the other handrail 28. As shown in FIG. 1, the buckle 130 may include electrical wiring to effect a lift interlock or change in lift operation relative to the state of the belt 120 (i.e., buckled or unbuckled). For example, a normally open switch may be disposed within the buckle 130 and linked to the electrical wiring, such that when the latch plate is inserted in the buckle 130, an electrical circuit is completed through the switch and wiring such that operation of the lift 20 is enabled. In yet another example, if the switch is opened at an intermediate position (e.g., during lift operation and between the ground and transfer elevations), the lift controller or logic board may take action to lower or raise the platform in an alternative operating mode as appropriate, relative to the platform's elevation, and operational control input, among other things.

In the illustrated embodiment of FIGS. 1 and 2, the retention device 100 is elevated above the platform surface such that a wheelchair does not flip or tip over upon contacting the retention device 100. For example, the retention device 100 may be located below the center of gravity for a typical wheelchair. In one exemplary embodiment, the retention device 100 is elevated approximately thirteen inches above the platform surface and is substantially flush with the outboard rollstop 26. In this exemplary embodiment, the retention device 100 acts like a barrier to retain the lift occupant and the occupant's mobility aid on the platform 22, thereby supplementing the outboard rollstop 26.

Referring now to FIG. 3, a parallel arm lift 200 is shown with a second embodiment of the retention device 100′. As shown, the lift 200 includes a platform 210 with sidewalls 220 and an outboard rollstop 230 pivotably coupled to the outboard edge of the platform 210. Proximate the inboard edge of the platform 210, the lifting arms 240 couple to the sidewalls 220. Elevated above the platform surface and extending in an outboard direction from the lifting arms 240 are handrails 250. Similar to the first embodiment, the retention device 100′, which is affixed to the handrails 250 and spans the platform 210 width, includes a belt retractor 110′, a belt 120′, and a buckle 130′. However, in its illustrated location intermediate the platform's inboard and outboard edges, the retention device 100′ is operative to supplement the outboard rollstop 230 by presenting a dynamic barrier which will substantially slow the progress of a lift occupant before contacting the outboard rollstop 230, such that the occupant and mobility aid do not flip or tip over upon contacting the rollstop 230. In an exemplary embodiment, the retention device 100′ is located just above seat height of a typical wheelchair, such as, for example, approximately twenty five inches above the surface of the platform 210.

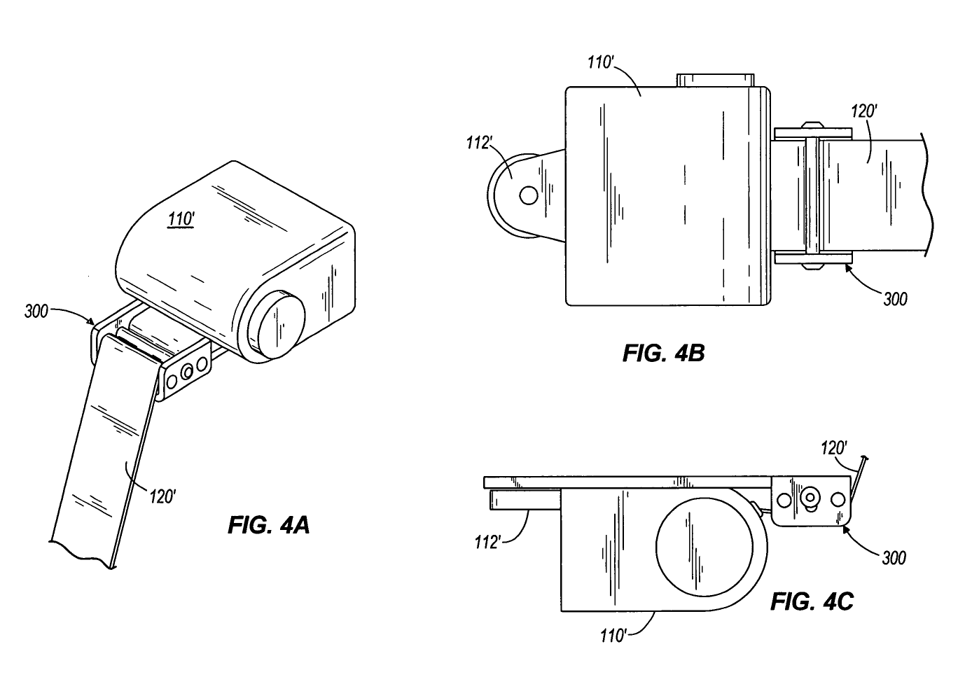

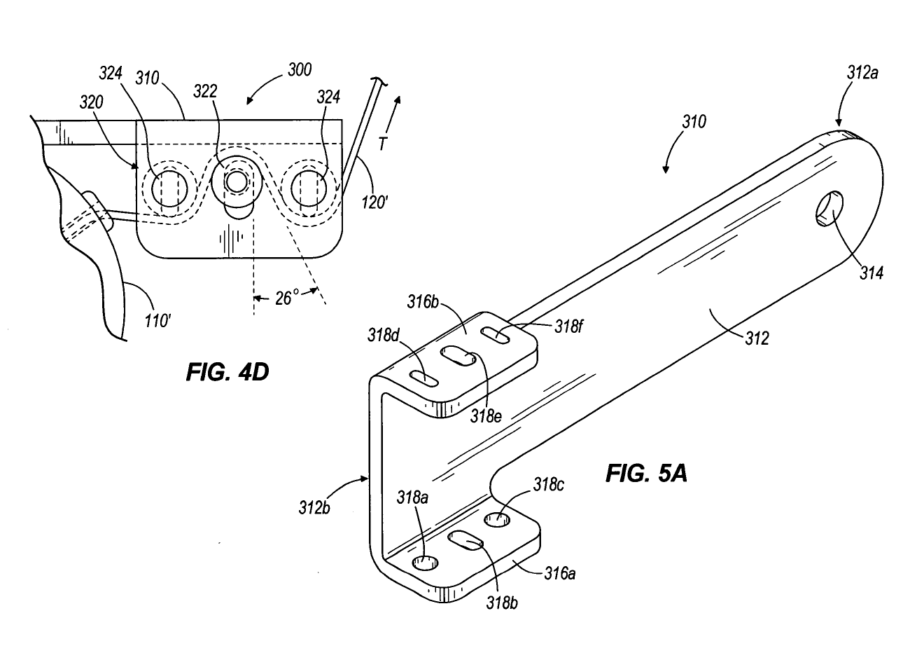

As shown in FIG. 3 and FIGS. 4A-4C, the belt retractor 110′ can include a damping mechanism 300, which is in line with the retractor 110′. The retractor 110′ illustrated in FIGS. 4A-4C is operative to release a spooled length of belt 120′ and does not include a locking mechanism. The in-line damping mechanism 300 is operative to impart a frictional damping force on the belt 120′, particularly as the belt 120′ extends from the retractor 110′. Referring to FIG. 4D, the damping mechanism 300 includes a bracket 310 for coupling the mechanism 300 in line with the retractor 110′, and a pin arrangement 320. As shown, the pins of the pin arrangement 320 are spaced apart and held captive within the bracket 310. The belt 120′ is woven between the pins, causing a normal contact force to be exerted on the belt 120′ by the pins as explained in further detail hereafter.

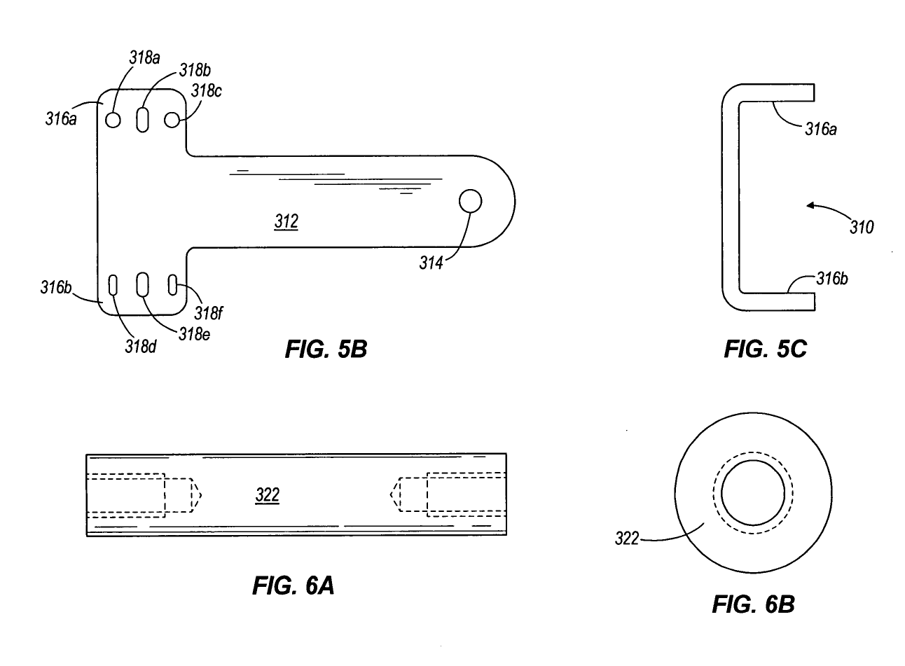

Referring now to FIGS. 5A-5C, the bracket 310 is described. The bracket 310 is formed of steel sheet or other suitable material and has an elongate body 312 with a first end 312a having a hole 314, and a second end 312b with opposing pin-retaining flanges 316a, 316b. The bracket 310 is coupled in line with the retractor 110′ by inserting a fastener (not shown) through the hole 314 and a corresponding hole in an interface plate 112′ of the retractor 110′ (see FIGS. 4B, 4C). The flanges 316a, 316b are bent or otherwise formed to be generally perpendicular with the body 312. When viewed end-on down the length of its elongate body 312, the bracket 310 has a “C” shape as shown in FIG. 5C. Referring now to FIG. 5B, each flange 316a, 316b has 3 holes 318a, 318b, 318c, and 318d, 318e, 318f respectively, which may be round, elliptical, or a combination of round and elliptical as shown, for supporting the pin arrangement 320 therebetween, although fewer or additional holes and pins are contemplated. As desired, the pins of the pin arrangement 320 may be welded, bolted, or a combination of welded and bolted, or otherwise permanently affixed to the bracket 310 such that the pins do not rotate in the holes.

Referring now to FIGS. 6A and 6B, the middle (adjustable) pin 322 is described. As shown, the exemplary middle pin 322 of the pin arrangement 320 is a cylindrical rod approximately 2″ long and ⅜″ in diameter. The exemplary pin 322 may be made of a ⅜″ C.R. steel rod or other suitable material. As shown in dotted lines of FIG. 6A, each end of the pin 322 is drilled and tapped to accept a screw, bolt or other like fastener. The exemplary pin 322 is drilled 0.5″ deep by a #25 bit, and thereafter tapped 0.375″ deep by a 10-24 UNC-2B or equivalent. Referring back to FIG. 5B, the middle pin 322 is adjustably retained between holes 318b and 318e by screws such as exemplary #10-24×½″ Allen screws. Thus retained, the middle pin 322 may be adjusted by loosening and tightening the screws to move the pin 322 toward or away from the body 312 as desired.

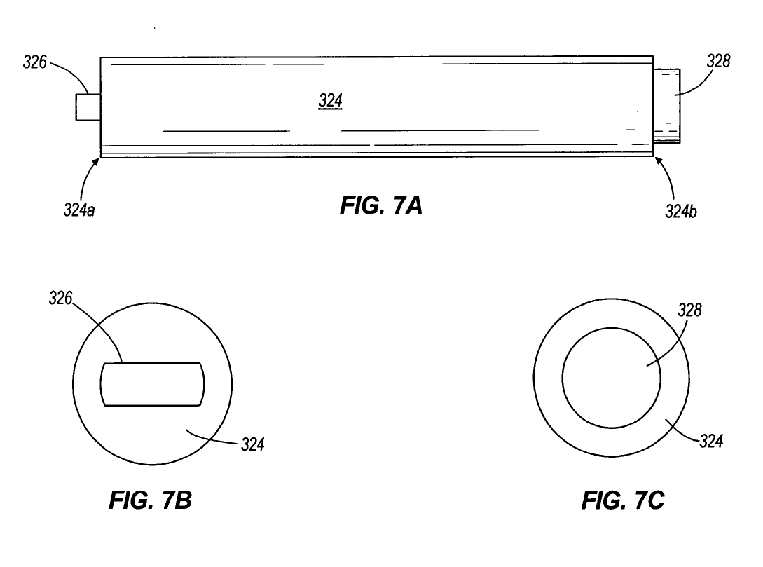

Referring now to FIGS. 7A-C, the end (fixed) pins 324 are described. As shown, the exemplary end pins 324 of the pin arrangement 320 are cylindrical rods approximately 2″ long and ⅜″ in diameter. The exemplary pins 324 may be made of a ⅜″ C.R. steel rod or other suitable material. As shown in FIG. 7A, the end pin 324 includes a first end 324a and a second end 324b. End views of the first and second ends 324a and 324b are shown in FIGS. 7B and 7C, respectively. Referring now to FIG. 7B, the first end 324a of the pin 324 includes a tab extension 326 that is sized and shaped to fit into holes 318d and 318f. In the exemplary embodiment illustrated in FIGS. 7A and 7B, the tab extension 326 extends from the first end 324a of the pin 324 approximately 0.1″, is approximately 0.1″ wide, and approximately 0.125″ long. The second end 324b includes a cylindrical extension 328 sized and shaped to fit into holes 318a and 318c. In the exemplary embodiment illustrated in FIGS. 7A and 7C, the cylindrical extension 328 extends from the second end 324b of the pin 324 approximately 0.1″, and has a diameter of approximately 0.24″. As illustrated, the tab extension 326 inhibits the pin 324 from rotating when inserted into the bracket flange 316b (holes 318d and 318f).

With reference to FIG. 4D, the normal force of the middle pin 322 on the belt 120′ is defined by the equation Fn=2T*cos(26°), where T is the tension in the belt 120′ and 26° is due to the orientation of the middle pin 322 relative to the end pins 324. This normal force causes a proportionate friction force parallel to and opposite the motion of the belt 120′. The friction force is defined by the equation F=2T*Cf, where T is the tension in the belt 120′, and Cf is the coefficient of friction between the seatbelt 120′ and the middle pin 322. The equations may vary given the geometry of the pin arrangement 320 and the physical properties of the individual pins and belt 120′. For example, by varying the distance between the center pin 322 and a line connecting the outer pins 324, the force on the belt 120′ due to friction is changed. Alternatively, the friction force may be changed by changing the distance between any two of the pins 322, 324. Additionally, the pins 322, 324 may be smoothed, textured, or be a combination of smooth and textured to vary the coefficient of friction between the belt 120′ and the pins 322, 324. In yet another embodiment, if desired, the belt 120′ may have a varying texture to provide for a varying coefficient of friction between the belt 120′ and the pins 322, 324.

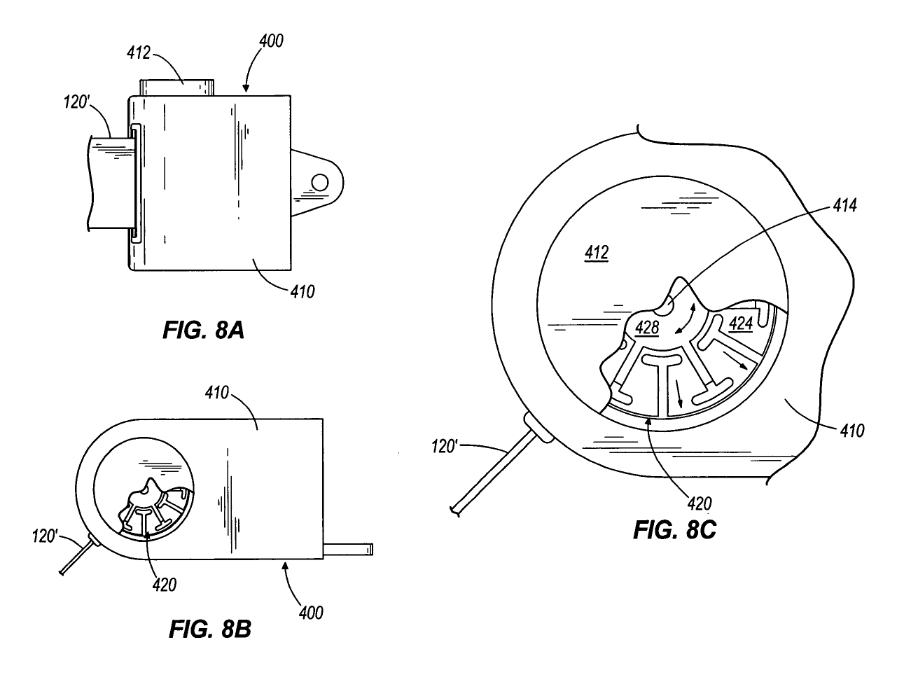

Referring now to FIGS. 8A-8C another exemplary embodiment of a damping mechanism for a wheelchair retention device is described. As shown in FIG. 8A, the housing 410 of the belt retractor 400 includes a cylindrical projection 412. A damping mechanism includes a non-locking centrifugal clutch assembly 420 disposed within the seatbelt retractor housing 410, and more particularly within the projection 412 of the housing 410. The centrifugal clutch assembly 420 is coupled to a seatbelt retractor spool 414 (see FIG. 8C). As is known, the spool 414 may include a spiraled spring, torsion spring or the like to retract the belt 120′ and take up any slack in the belt 120′ when buckled. As shown in FIGS. 8B and 8C, the centrifugal clutch assembly 420 includes a centrifugal clutch plate 424 and a clutch plate driver 428. The clutch plate 424 is sized and shaped to fit within the inner diameter of the housing projection 412 and rotate freely therein as the belt 120′ moves at slow speeds. The driver 428 is coupled with the seatbelt spool 414 to rotate as the belt 120′ extends and retracts from spool 414. As shown, the driver 428 is sized and shaped to matingly engage with the plate 424 to rotate the plate 424 as the belt 120′ moves into and out from the retractor 400. As the driver 428 rotates the plate 424, portions of the perimeter of the plate 424 expand against the inner diameter of the projection 412 (shown by outward arrows in FIG. 8C), thereby creating a friction force to slow the belt 120′.

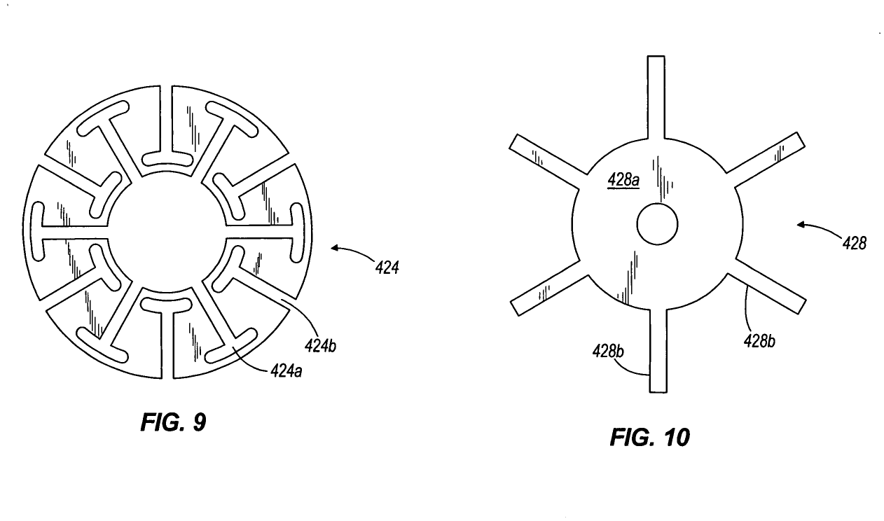

Referring now to FIG. 9, the centrifugal clutch plate 424 is described. The exemplary illustrated plate 424 is generally toroidal in shape as shown. The exemplary plate 424 may be fabricated or formed of 0.125″ thick ABS plastic sheet, and has an outer diameter of 1.5″ and an inner diameter of 0.625″. As shown, the plate 424 includes a plurality of “T” cutouts 424a and inverse “T” cutouts 424b. As illustrated, there are six “T” cutouts 424a, which open toward the inner diameter of the plate 424, and six inverse “T” cutouts 424b, which open toward the outer diameter of the plate 424. Adjacent cutouts 424a, 424b are spaced apart by approximately thirty degrees. The inverse “T” cutouts 424b permit the plate 424 to flex while keeping a large portion of the plate perimeter intact, thereby maximizing the contact between the plate 424 and the inner diameter of the projection 412. The “T” cutouts 424a are sized and shaped to matingly engage with the driver 428.

Referring now to FIG. 10, the clutch plate driver 428 is described. The exemplary illustrated driver 428 is a generally star-shaped member with six spokes, although fewer or additional spokes are contemplated relative to the arrangement of cutouts 424a of the plate 424. The driver 428 is made of 0.06″ thick (16 gauge) C.R. steel sheet or other suitable material. As shown, the driver 428 includes a toroidal-shaped body 428a having a central hole that mates with the spool 414, and a plurality of spokes 428b. One exemplary driver 428 has a body 428a with an outer diameter of approximately 0.62″ and a 0.145″ diameter central hole. As shown, the exemplary driver 428 has six spokes 428b that are equally spaced apart by sixty degrees. However, fewer or additional spokes 428b are contemplated. As shown, the spokes 428b correspond to the number and orientation of the “T” cutouts 424a of the centrifugal plate 424, and extend approximately 0.3″ outward from the body's perimeter.

From a fully retracted belt position, a lift platform occupant or lift operator may extend the belt 120′ at a relatively slow and/or constant (low or no damping) rate across the platform width, and thereafter engage the latch plate with the buckle 130′. If a malfunction or improper operation were to occur with the occupant's wheelchair (particularly a powered wheelchair), or the lift's mechanics or controls, such that the lift occupant advances toward the outboard edge of the platform 210, the occupant will first contact the belt 120′, thereby causing the spooled portion of the belt 120′ to unspool or extend at a relatively fast rate. The spool 414 rotates to spin the plate driver 428 and mated clutch plate 424. The clutch plate 424 flexes as it spins with the driver 428, and portions of the plate's perimeter expand outward to contact the inner diameter of the projection 412, thereby creating a friction force that slows and dampens the speed and/or acceleration of the belt's extension. Consequently, the lift occupant is slowed substantially prior to contacting the outboard barrier 230. Thus, upon contacting the outboard barrier 230, the occupant's wheelchair is inhibited from climbing the barrier 230, and further, does not tip or flip over.

All references, including publications, patent applications, and patents, cited herein are hereby incorporated by reference to the same extent as if each reference were individually and specifically indicated to be incorporated by reference and were set forth in its entirety herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. For example, the damping mechanisms described and illustrated herein may include other non-locking mechanical friction devices known in the art. Additionally, the illustrated centrifugal clutch plate 424 and driver 428 may have other geometries that generate frictional damping forces. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An occupant lift for a vehicle, the occupant lift adapted to support a wheelchair and comprising:
a platform coupled to and movable to different positions with respect to the vehicle, the platform comprising
a top surface adapted to support the wheelchair on the lift;
an inboard end adjacent the vehicle when the platform is deployed;
an outboard end opposite the inboard end; and
an elongated barrier having a first position when the platform is deployed to block occupant movement off of the outboard end of the platform, wherein the elongated barrier is located a distance from the top surface of the platform no greater than about a height of a center of gravity of the wheelchair upon the platform.

2. The occupant lift as claimed in claim 1, wherein:
the elongated barrier has a second position removed from the first position; and
the elongated barrier is positioned to permit occupant movement toward and off the outboard end of the platform when the elongated barrier is in the second position

3. The occupant lift as claimed in claim 1, wherein the elongated barrier is positioned adjacent the outboard end of the platform in the first position of the elongated barrier.

4. The occupant lift as claimed in claim 1, wherein the elongated barrier is flexible.

5. The occupant lift as claimed in claim 4, wherein the elongated barrier is a belt.

6. The occupant lift as claimed in claim 1, wherein
the elongated barrier is extendible from the second position, in a first direction across the platform, and to the first position; and
the elongated barrier is retractable from the first position, in a second direction across the platform, and to the second position.

7. The occupant lift as claimed in claim 6, wherein the elongated barrier is in an at least partially wound state in the second position.

8. The occupant lift as claimed in claim 6, wherein the elongated barrier is biased toward the second position.

9. The occupant lift as claimed in claim 1, further comprising a damper coupled to the elongated barrier, the damper generating resistance to movement of the elongated barrier in at least one direction of the elongated barrier.

10. The occupant lift as claimed in claim 9, wherein:
the damper comprises a clutch coupled to the elongated barrier; and
the resistance to movement of the elongated barrier is generated by frictional forces from the clutch.

11. The occupant lift as claimed in claim 9, wherein:
the damper comprises at least two pins between which the elongated barrier is passed; and
the resistance to movement of the elongated barrier is generated by frictional forces between the at least two pins and the elongated barrier.

12. An occupant retention device for a vehicular occupant lift having a platform with an inboard end and an outboard end, the occupant retention device comprising:
an elongated barrier adapted to be coupled to the lift and movable between an extended position in which the elongated barrier is positioned to block occupant movement off of the outboard end of the platform, and a retracted position in which the elongated barrier does not block occupant movement off of the outboard end of the platform; and
a damper coupled to the elongated barrier, the damper exerting a force resisting motion of the elongated barrier in at least one direction in order to reduce the rate of extension of the elongated barrier.

13. The occupant retention device as claimed in claim 12 for a vehicular lift having a platform with opposite sides, wherein the elongated barrier extends substantially to and between the opposite sides of the platform.

14. The occupant retention device as claimed in claim 12, wherein the elongated barrier is located over the platform and at a higher elevation than the platform in the extended position.

15. The occupant retention device as claimed in claim 12, wherein:
the damper comprises a clutch; and
the force resisting motion of the elongated barrier is generated by friction from the clutch.

16. The occupant retention device as claimed in claim 15, wherein the elongated barrier is at least partially wound about a spool in the retracted position of the elongated barrier.

17. The occupant retention device as claimed in claim 15, wherein the clutch generates increased frictional force responsive to centrifugal force generated by clutch rotation.

18. The occupant retention device as claimed in claim 12, wherein the damper comprises at least two pins between which the elongated barrier is passed.

19. The occupant retention device as claimed in claim 18, wherein at least one of the two pins is adjustable to different positions with respect to another of the at least two pins.

20. The occupant retention device as claimed in claim 12, wherein the elongated barrier is a belt.

21. A method of controlling occupant movement from a platform of a vehicle occupant lift adapted to support a wheelchair, the method comprising:
extending an elongated barrier to an extended position across the platform at a location above and disposed from a top surface of the platform by a distance no greater than about a height of a center of gravity of the wheelchair;
securing the elongated barrier in the extended position; and
blocking the occupant from passing across an end of the platform with the elongated barrier.

22. The method as claimed in claim 21, further comprising:
further extending the elongated barrier responsive to blocking the occupant; and
exerting a damping force resisting further extension of the elongated barrier responsive to further extending the elongated barrier.

23. The method as claimed in claim 22, wherein exerting the damping force comprises generating increased frictional force to resist further extension of the elongated barrier.

24. The method as claimed in claim 21, wherein extending the elongated barrier comprises at least partially unwinding the elongated barrier.

25. A method of controlling occupant movement from a platform of a vehicle occupant lift, the method comprising:
extending an elongated barrier to an extended position across the platform at a location above and disposed from a top surface of the platform;
securing the elongated barrier in the extended position;
blocking the occupant from passing across an end of the platform with the elongated barrier in the extended position; and
exerting a damping force resisting further extension of the elongated barrier responsive to occupant movement against the elongated barrier.

26. The method as claimed in claim 25, wherein exerting the damping force comprises generating increased frictional force to resist further extension of the elongated barrier.

27. The method as claimed in claim 25, wherein extending the elongated barrier comprises at least partially unwinding the elongated barrier.

28. An occupant retention device for a vehicular occupant lift having a platform with an inboard end, an outboard end, and a top surface adapted to support a wheelchair, the occupant retention device comprising:
an elongated barrier adapted to be coupled to the vehicular occupant lift in a first position located a distance above the top surface of the platform no greater than about a height of a center of gravity of the wheelchair upon the platform and in which the elongated barrier blocks occupant movement off of the outboard end of the platform
